(19) United States
(12) Patent Application Publication
(10) Pub. No.: US 2023/0151600 A1
(43) Pub. Date: May 18, 2023

(54) SHEATHED FLEXIBLE SHAFT DRAIN CLEANER

(71) Applicant: Emerson Professional Tools, LLC., Elyria, OH (US)

(72) Inventors: Michael J. Rutkowski, North Royalton, OH (US); Nicholas Christopher MAVROS, Columbia Station, OH (US); Jacob SCHNEIDER, Elyria, OH (US); Stephen OSHGAN, Arlington Heights, IL (US); Jason GEBHARDT, Arlington Heights, IL (US); Patrick John MCVEY, Arlington Heights, IL (US)

(21) Appl. No.: 17/975,280

(22) Filed: Oct. 27, 2022

Related U.S. Application Data
(60) Provisional application No. 63/279,351, filed on Nov. 15, 2021.

(51) Int. Cl. E03C 1/302; B08B 9/045

(52) U.S. Cl. CPC E03C 1/302; B08B 9/045; B08B 2209/04

(57) ABSTRACT

A drain cleaner is disclosed having a housing with an interior region for storing a flexible drain cleaning cable. The drain cleaning cable can be extended from the drain cleaner and includes a rotatable member within a non-rotating sheath. The drain cleaner includes an engageable drive shaft coupled to the rotatable member. In certain versions, the drive shaft is coupled to the rotatable member through a torque limiting device such as a clutch. Upon engagement of the drive shaft with a rotary power source, a rotating distal end of the flexible cable can be used to dislodge obstructions in pipes. The interior region of the drain cleaner is configured to promote efficient coiling of the drain cleaning cable. The drain cleaner includes additional features for reducing wear of cable and components, and securely retaining the cable to the drain cleaner.

### CROSS REFERENCES TO RELATED APPLICATIONS

This application claims priority from U.S. provisional application Ser. No. 63/279,351 filed on Nov. 15, 2021.

### FIELD

The present subject matter relates to drain cleaning equipment and particularly drain cleaning equipment using sheathed flexible shaft drain cleaning cables.

### BACKGROUND

A wide array of drain cleaning equipment is known. Flex shaft type drain cleaners use a rotatable, flexible cable member enclosed within a non-rotating sheath. The cable member and sheath typically are positioned inside a round channel of a drum or other housing component of the drain cleaner.

Flex shaft type drain cleaners typically enable an operator to extend or retract the flexible cable from the drain cleaner, such as in applications in which a distal end of the cable is inserted into a blocked or obstructed pipe or other member. Engagement or other application of a rotary power source to a proximal end of the flexible cable, such as at the drain cleaner, results in powered rotation of the cable member within the sheath. Various tools such as rotating cutting heads can be attached at the distal end of the cable for removal of blockage or other operations within the pipe.

Certain flex shaft type drain cleaners are typically operated in a horizontal orientation, in which a cable guide tube rotates about a vertically oriented axis as flexible cable is extended or retracted relative to the drain cleaner. This promotes coiling of the cable around the interior drum channel upon retraction of the cable into the drain cleaner.

Although satisfactory in many respects, a need exists for improved drain cleaning equipment and particularly such equipment using sheathed flexible shaft drain cleaning cables.

### SUMMARY

The difficulties and drawbacks associated with previous approaches are addressed in the present subject matter as follows.

In one aspect, the present subject matter provides a drain cleaner comprising a first housing component and a second housing component. The first and the second housing components are sized and shaped to matingly engage each other to define a generally enclosed interior region. The drain cleaner also comprises a cable clamp mount assembly disposed within the interior region. The cable clamp mount assembly defines a shaft receiving region. The drain cleaner additionally comprises a rotary power shaft assembly for receiving rotary power. The rotary power shaft assembly is disposed in the shaft receiving region and at least partially supported by the cable clamp mount assembly. The shaft receiving region defines an inclination angle within a range of from 10° to 80°.

In another aspect, the present subject matter provides a drain cleaner comprising a first housing component defining a centrally located cable port and a second housing component. The first and the second housing components are sized and shaped to matingly engage each other to define a generally enclosed interior region. The second housing component defines an inner cone support member. The inner cone support member and the cable port defined in the first housing component are aligned and share a common center axis.

In yet another aspect, the present subject matter provides a drain cleaner comprising a first housing component defining a centrally located cable port and a second housing component. The first and the second housing components are sized and shaped to matingly engage each other to define a generally enclosed interior region. The second housing component defines an inner cone support member. The drain cleaner also comprises a cable clamp mount assembly disposed within the interior region. The drain cleaner additionally comprises a rotary power shaft assembly. The rotary power shaft assembly is at least partially supported by the cable clamp mount assembly.

In still another embodiment, the present subject matter provides a drain cleaner comprising a housing that defines a generally hollow interior. The housing further defines a first face, an oppositely directed second face, and an inner cone support member extending within the hollow interior. The first face of the housing defines an opening. The drain cleaner further comprises a cable clamp mount assembly disposed within the hollow interior of the housing. The cable clamp mount assembly defines a shaft receiving region that defines an inclination angle within a range of from 10° to 80°. The drain cleaner further comprises a removable housing cap sized and shaped to releasably engage the opening defined in the first phase of the housing.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 illustrates a top perspective view of an embodiment of a drain cleaner in accordance with the present subject matter.

FIG. 2 is a schematic partially exploded assembly view of the drain cleaner depicted in FIG. 1.

FIG. 3 is a top view of the drain cleaner shown in FIG. 1.

FIG. 4 is a schematic cross sectional view of the drain cleaner of FIG. 1, taken along a section line shown in FIG. 3.

FIG. 5 is a bottom perspective view of the drain cleaner of FIG. 1.

FIG. 6 is a schematic exploded assembly view of an embodiment of a cable clamp mount assembly in accordance with the present subject matter.

FIG. 7 is a top perspective view of the drain cleaner of FIG. 1 with an optional wear insert component.

FIG. 8 is a top view of the drain cleaner and wear insert component depicted in FIG. 7.

FIG. 9 is a schematic cross sectional view of the drain cleaner and wear insert component taken across a section line shown FIG. 8.

FIG. 10 is a perspective view of a portion of an interior region of the drain cleaner of FIG. 1 illustrating an embodiment of a cable guide tube.

FIG. 11 is a schematic side elevational view of the cable guide tube shown in FIG. 10.

FIG. 12 is another schematic side elevational view of the cable guide tube.

FIG. 13 is a top schematic view of the cable guide tube.

FIG. 14 is a schematic exploded assembly view of the cable clamp mount assembly of FIG. 6 optionally used in conjunction with a clutch assembly, in accordance with the present subject matter.

FIG. 15 is a top perspective view of the drain cleaner of FIG. 1 with an optional locking clip.

FIGS. 16 and 17 illustrate the locking clip in a locked position.

FIG. 18 illustrates the locking clip in an unlocked position.

FIG. 19 is a schematic side elevational view of an alternate member used in a cable clamp mount assembly in accordance with the present subject matter.

FIG. 20 is a top view of the alternate member shown in FIG. 19.

FIG. 21 is an end view of the alternate member shown in FIG. 19.

FIG. 22 is a bottom perspective view of another embodiment of a drain cleaner in accordance with the present subject matter.

FIG. 23 is a top view of the drain cleaner illustrated in FIG. 22.

FIG. 24 is a bottom view of the drain cleaner of FIG. 22.

FIGS. 25-28 are end views of the drain cleaner depicted in FIG. 22.

FIG. 29 is a partially exploded assembly view of the drain cleaner of FIG. 22.

FIG. 30 is a detailed view of a housing cap used in the drain cleaner of FIG. 22.

FIG. 31 is another detailed view of the housing cap illustrated in FIG. 30.

FIGS. 32-35 illustrate operations of unlocking and removing the housing cap from a drain cleaner and accessing a distal end of a drain cleaning cable retained by the housing cap.

FIG. 36 is a partial schematic cross section of the drain cleaner illustrated in FIG. 22.

### DETAILED DESCRIPTION OF THE EMBODIMENTS

The present subject matter provides drain cleaners adapted for use with a sheathed flexible drain cleaning cable. The cable or multiple sections of cable engaged together, can be conveniently and neatly coiled in an interior region of the drain cleaner. A proximal end of the drain cleaning cable retained within the drain cleaner is engaged to a drive shaft assembly. A rotary power source can be engaged to the drive shaft assembly alongside the exterior of the drain cleaner. Application of rotary power to the drive shaft results in rotation of a flexible cable member enclosed within a non-rotating sheath of the drain cleaning cable. The distal end of the drain cleaning cable is extended from a housing cap opening, a cable port opening, or a cable outlet in the housing of the drain cleaner. An operator can easily extend drain cleaning cable from the drain cleaner and utilize the distal end of the cable to dislodge pipe obstructions. A unique configuration inside the drain cleaner enables the operator to readily collect extended cable back within the interior region of the drain cleaner in a stacked coil. It will be recognized that the present subject matter includes configurations in which the cable is not collected in a stacked coil. For example, the cable could be collected in a coil in which the cable is not necessarily stacked. Moreover, the present subject matter includes configurations in which the cable is collected in a random fashion with the interior region of the housing. Additional features are described that enable the drain cleaning cable to be conveniently secured to the housing of the drain cleaner.

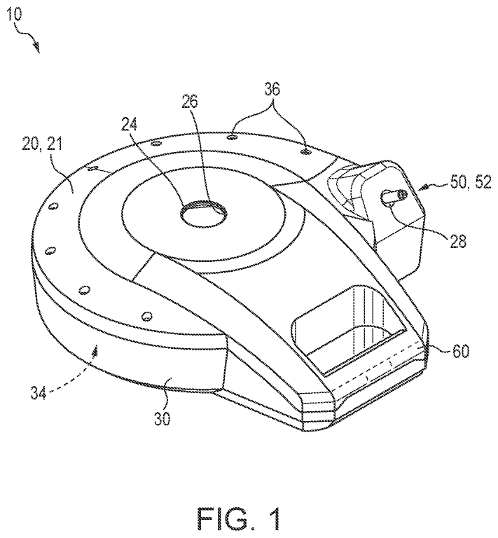

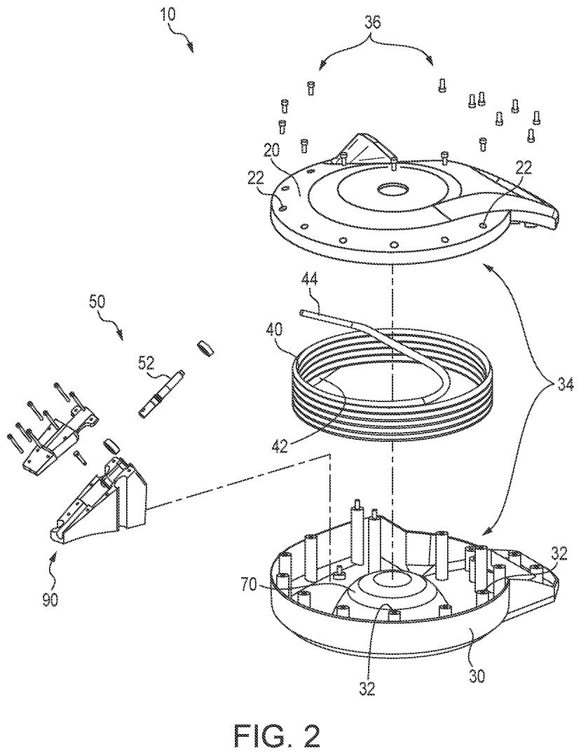

FIGS. 1 and 2 illustrate an embodiment of a drain cleaner 10 in accordance with the present subject matter. The drain cleaner 10 comprises a first or top housing component 20 and a second or bottom housing component 30. The top and bottom housing components 20, 30 are sized and shaped to matingly engage each other to define a generally enclosed hollow interior region 34. The present subject matter includes an embodiment utilizing a single or integral housing, i.e., without multiple housing components. The resulting housing is generally toroidal in shape. One or more sections of a flexible shaft drain cleaning cable 40 are disposed at least partially within the interior region 34. The flexible cable 40 defines a proximal end 42 and an opposite distal end 44. The drain cleaner 10 also comprises a rotary power shaft assembly 50, generally supported by one or both of the top and bottom housing components 20, 30. The drain cleaner 10 may also comprise one or more handle(s) and/or gripping member(s) for facilitating carrying and/or use by an operator. In the illustrated embodiment, the drain cleaner 10 comprises a handle 60. As described in greater detail herein, the drain cleaner 10 also comprises an inner cone support member 70 which facilitates administration of flexible cable 40 within the interior region 34 of the drain cleaner 10. The drain cleaner 10 also comprises a cable clamp mount assembly 90 disposed within the interior region 34 of the drain cleaner 10. As described in greater detail herein, the cable clamp mount assembly 90 supports the rotary power shaft assembly 50 and orients the proximal end 42 of the flexible cable 40 for improved engagement with the rotary power shaft assembly 50.

Referring further to FIGS. 1 and 2, the first and second housing components 20, 30 are affixed or otherwise secured to each other. In the depicted drain cleaner 10, a plurality of fasteners 36 are used to releasably engage the first and second housing components 20, 30 together. As will be understood, apertures 22 can be defined in the first housing component 20 and corresponding receiving members 32 provided in the second housing component 30. The apertures 22 and receiving members 32 are aligned and adapted to engagingly receive the fasteners 36. As will be appreciated, other configurations and/or components can be used to secure the first and second housing components 20, 30 together. Also, as previously noted, the present subject matter includes the use of a single housing rather than multiple housing components that are affixed or engaged together. The present subject matter also includes housing components that are attached by releasable fasteners such as latches and/or if a housing cap is not utilized.

The first housing component 20 defines a centrally located cable port 26 providing access to the interior region 34 defined by the housing components 20, 30. In certain versions, the first housing component 20 also defines a conical tapered edge 24 extending about the cable port 26. The conical tapered edge 24 can be in the form of a funnel or depression along an exterior or first face 21 of the first housing 20 extending around the periphery of the cable port 26. As described in greater detail herein, upon placement of the flexible cable 40 within the interior region 34, the distal end 44 and portion of the cable 40 can be extended through the cable outlet or cable port 26. In versions of the first housing component 20 defining the noted conical region 24, that region 24 symmetrically extends about the cable port 26. The conical region 24 promotes and/or facilitates cable feeding, cable retrieval, or other cable administration operation(s).

The drain cleaner 10 also defines an accessway 28 in one or both of the first and second housing components 20, 30 through which the rotary power shaft assembly 50 is accessible. In the depicted embodiment, drain cleaner 10, the accessway 28 is in the form of an opening in the first housing component 20 sized and shaped to enable engagement to the rotary power shaft assembly 50. As described in greater detail herein, the accessway 28 is configured to allow convenient access to an outwardly extending drive shaft 52 of the rotary power shaft assembly 50. In certain versions, the accessway 28 is configured to also allow ready engagement to the drive shaft 52 extending outward at an acute angle or an angle between and including 0 degrees and 90 degrees, relative to a plane generally bisecting the housing components 20, 30, and generally parallel to their interface. It will be understood that the present subject matter includes a variety of arrangements and orientations of the accessway 28 and drive shaft 52. For example, the drive shaft 52 can in certain versions extend outward in a direction parallel to the noted plane. In such a configuration, the noted angle is 0 degrees. The particular angular orientation of the drive shaft 52 in certain versions, is described in greater detail herein.

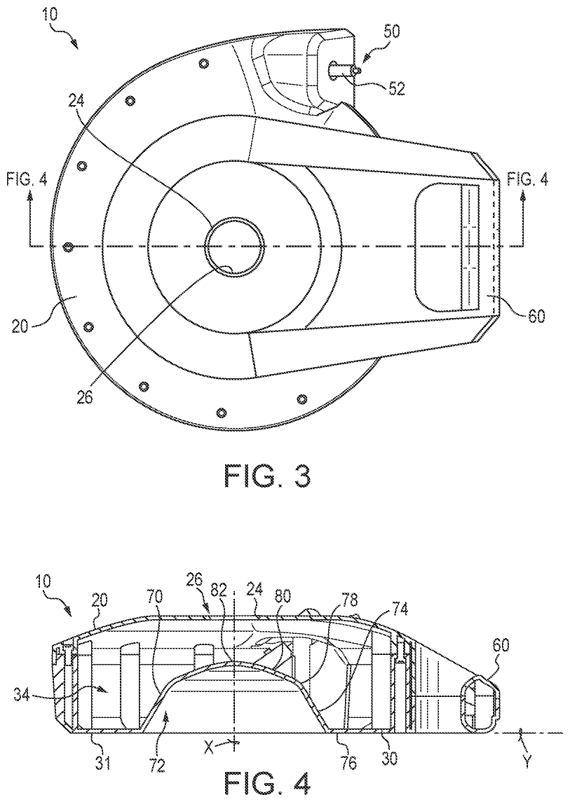

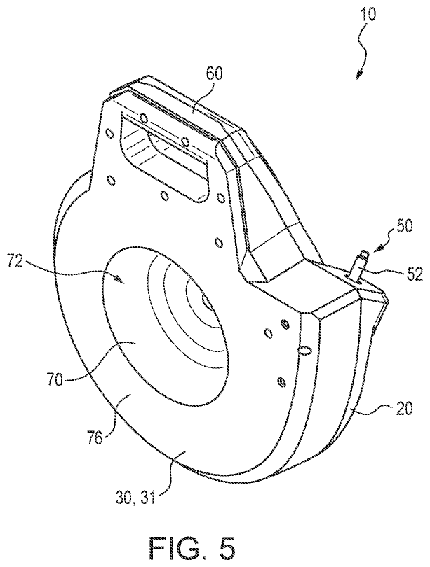

FIGS. 3-5 illustrate the drain cleaner 10 and various features in greater detail. Specifically, FIG. 4 is a cross section taken across a section line shown in FIG. 3 and illustrates the inner cone support member 70. The inner cone support member 70 extends into the interior region 34 of the drain cleaner 10. Viewed from an exterior or second face 31 of the second housing component 30, the configuration of the inner cone support member 70 provides an exterior recessed region 72 along the exterior face 31. However, it will be understood that the second housing component 30 can include structures or members to avoid the recessed region 72, such as a flat planar member (not shown). The inner cone support member 70 is generally aligned with and centrally disposed relative to the cable port 26. Referring to FIG. 4, preferably the inner cone support member 70 and the cable port 26 share a common center axis illustrated as axis X.

In particular versions, the inner cone support member 70 exhibits a dual conical configuration as follows. The support member 70 includes a first conical region 74 extending between a planar wall 76 of the second housing component 30 and a circular belt line 78 defined about the periphery of the support member 70. The support member 70 includes a second conical region 80 extending between the belt line 78 and an apex 82 of the support member 70. In this version, the configuration of the first conical region 74 is different than that of the second conical region 80. More specifically, when viewed in cross section such as in FIG. 4, an angle of wall orientation of the first conical region 74 is different than an angle of wall orientation of the second conical region 80. For example, generally the angle of wall orientation of the first conical region 74, taken with respect to a plane Y of the planar wall 76, is within a range of from 45° to 80° and preferably about 55°. Generally, the angle of wall orientation of the second conical region 80, taken with respect to the plane Y, is within a range of from 10° to 45° and preferably about 35°. The relatively large angle of the first conical region 74 improves cable retention within the interior region 34 of the drain cleaner 10. The relatively small angle of the second conical region 80 promotes and directs cable into a coiled arrangement within the interior region 34 of the drain cleaner 10.

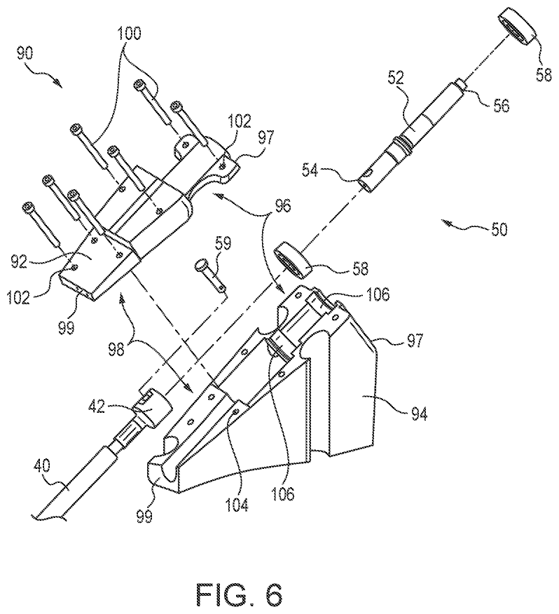

FIG. 6 illustrates the rotary power shaft assembly 50 and the cable clamp mount assembly 90 in greater detail. FIG. 6 also illustrates the proximal end 42 of the flexible drain cleaning cable 40. The rotary power shaft assembly 50 includes a drive shaft 52. The drive shaft 52 defines a proximal end 54 and an opposite distal end 56. The proximal end 54 is adapted for coupling or other affixment to the proximal end 42 of the flexible cable 40. Generally, the proximal end 54 of the drive shaft 52 is engaged to the proximal end 42 of the flexible cable 40 at a location within the interior region 34 of the drain cleaner 10. A retaining pin 59 can be used to affix the proximal end 42 of the flexible cable 40 to the proximal end 54 of the drive shaft 52. The distal end 56 of the drive shaft 52 is adapted for engagement to a rotary power source (not shown). Examples of rotary power sources can include hand-held electrically powered drills. Preferably, the hand-held electrically powered drill is a battery powered drill. It will be understood that the distal end 56 of the drive shaft 52 is accessible through the previously described accessway 28 defined in the housing of the drain cleaner. The distal end 56 of the drive shaft 52 can include a variety of cross sectional shapes such as for example square or hexagonal to promote engage with a rotary power source. The rotary power shaft assembly 50 may also comprise one or more bearings 58 to promote rotation of the shaft 52 and/or rotatably support the shaft 52. Typically, engagement between a rotary power source and the distal end 56 of the drive shaft 52 occurs at a location along the exterior of the drain cleaner 10. In certain applications and particularly if the rotary power source is in the form of a hand-held electrically powered drill such as a battery powered drill, the drill can be positioned in contact with one or both of the first and second housing components 20, 30. The exterior contour of the drain cleaner 10 can be configured to contact and receive a typical hand-held drill placed in or on the housing such that the housing counteracts torque from operation of the drill. It will be understood that the present subject matter includes a wide array of placement and/or positioning arrangements of the rotary power source relative to the drain cleaner 10.

The cable clamp mount assembly 90 typically includes a first or top member 92 and a second or base member 94. One or both of the first and second members 92, 94 define a shaft receiving region 96 at one end 97 and a cable receiving region 98 at another end 99. Upon placement and engagement of the first and second members 92, 94 to each other, the shaft receiving region 96 is sized and shaped to receive at least a portion of the drive shaft 52, and the cable receiving region 98 is sized and shaped to receive the proximal end 42 of the flexible cable 40 and at least a portion of the flexible cable 40. Specifically, upon engagement of the first member 92 with the second member 94, the resulting engagement defines a shaft receiving region 96 at one end 97, and a cable receiving region 98 at another end 99 of the resulting engagement. A plurality of fasteners 100 can be used to releasably engage the first and second members 92, 94 together. As will be understood, apertures 102 can be defined in the first member 92 and corresponding receiving regions 104 provided in the second member 94. One or more bearing support regions 106 can be provided in one or both of the first and/or second members 92, 94. As will be understood, the bearing support regions 106 are sized and shaped to receive, retain, and support the bearings 58. In certain versions, the first member 92 and/or the second member 94 serve to both clamp and secure the distal end 42 of the drain cleaning cable 40 and also clamp and secure the bearing(s) 58.

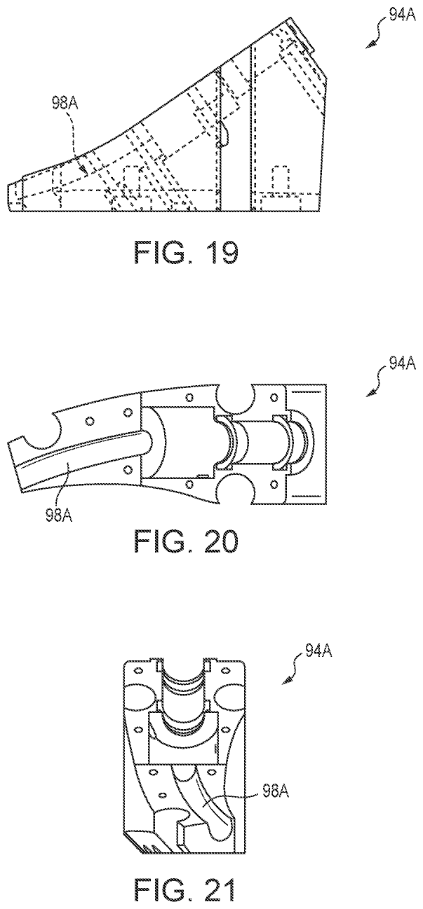

In particular versions of the cable clamp mount assembly 90, the cable receiving region 98 defined by the first and/or the second member 94 extends along a curved or arcuate axis, and in certain versions extends along a helical axis. Referring to FIGS. 19-21, a second member 94A is illustrated which exhibits a helical cable receiving region 98A. It will be understood, that the second member 94A can be utilized in a cable clamp mount assembly similar to the previously described assembly 90 depicted in FIG. 6. Specifically, with reference to FIGS. 19-21, the second member 94A defines a helical cable receiving region 98A. A helical configuration of the cable receiving region 98A provides an arcuate or curved path for the cable receiving region 98A in both a first plane such as when viewing the member 94A from its top as shown in FIG. 20 and also in a second plane, perpendicular to the first plane, such as when viewing the member 94A from its end as shown in FIG. 21. This particular configuration of the cable receiving region 98A and/or the member 94A results in improved operational efficiency and reduces potential for binding or wear of a drain cleaning cable positioned within the cable receiving region 98A. It will be understood that the present subject matter includes variant configurations such as a non-helical path for the cable receiving region 98 for example a configuration in which the region 98 extends in an arcuate fashion in only one of the noted planes.

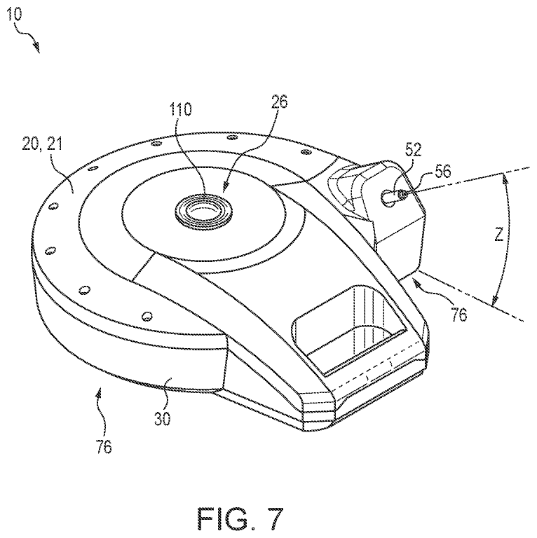

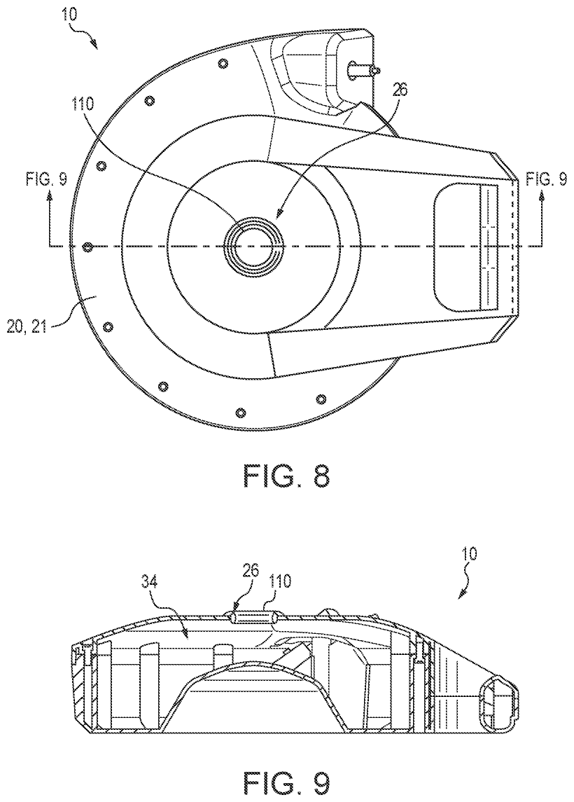

FIGS. 7-9 illustrate an optional wear insert component 110 utilized in the embodiment of the drain cleaner 10. As previously described, the first housing component 20 defines a cable outlet or cable port 26 providing access, i.e., entry and/or exit, to the interior region 34 defined by the engaged first and second housing components 20, 30. The wear insert component 110 is sized and shaped to fittingly engage the portion of the housing component 20 defining the cable port 26. Typically, the cable port 26 exhibits a circular opening shape, and so the wear insert component 110 is also circular in shape. However, it will be understood that the present subject matter includes other shapes and configurations. Furthermore, in certain versions, the wear insert component 110 is rotatably engaged with the first housing component 20, and so the component 110 can be rotated in its engaged affixment in the cable port 26. Again, it will be appreciated that the present subject matter includes a wide array of other configurations and versions of the wear component for example non-rotatable engagements and non-circular shapes.

The wear insert component 110 serves to provide a low friction point of contact for flexible drain cleaning cable 40 entering or exiting the interior region 34 of the drain cleaner 10. Thus, in many versions, the wear insert component 110 is formed from or includes an outer coating of a low friction material such as but not limited to polytetrafluoroethylene (PTFE), nylon-based materials, and/or acetal-based materials as known in the art. The present subject matter includes the use of other low friction materials. It is contemplated that the wear insert component 110 could be easily replaced if exhibiting excessive wear.

FIG. 7 also illustrates another aspect of particular versions of drain cleaners such as the depicted embodiment, drain cleaner 10. In this aspect, the outwardly extending distal end 56 of the drive shaft 52 is oriented within a range of angles of from about 10° to about 80°, and in certain versions at about 30°. These noted angles are shown in FIG. 7 as angle Z and are taken with regard to the previously noted planar wall 76 of the second housing component 30. The angular orientation of the drive shaft 52 can be achieved by the configuration of the cable clamp mount assembly 90. In many embodiments, the angular orientation of the drive shaft 52 is determined by an inclination angle defined by the shaft receiving region 96 of the cable clamp mount assembly 90. This inclination angle is expressed as previously described angle Z. Thus, the inclination angle of the shaft receiving region typically is within a range of from about 10° to about 80°, and in certain versions is about 30°. Angular orientation of the drive shaft 52 may promote ergonomic placement and positioning of a hand-held drill alongside the drain cleaner. However, it will be understood that the present subject matter includes other configurations and drive shaft orientations. For example, the subject matter includes drain cleaners with a drive shaft oriented to extend at an angle perpendicular or substantially so to a plane bisecting the housing components 20, 30 and parallel to their interface. The subject matter also includes drain cleaners with a drive shaft oriented to extend at an angle parallel or substantially so to a plane bisecting the housing components 20, 30 and parallel to their interface. The drive shaft 52 is located on one side of the housing spaced apart from the center of the housing. The position of the drive shaft 52 and the cable clamp mount assembly 90 is such that the power transmission is directed substantially tangential to the coiled portion of flexible cable 40 within the interior chamber 34 of the drain cleaner 10.

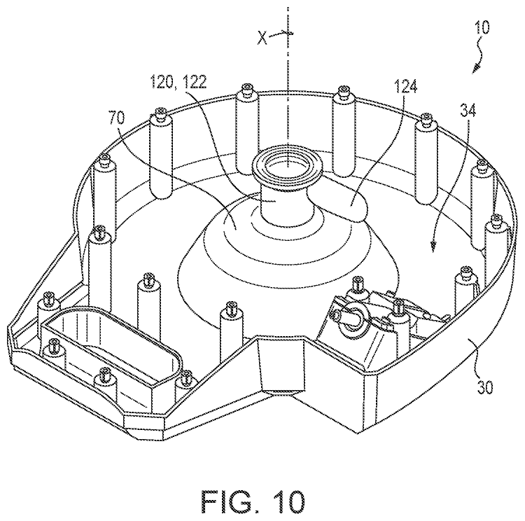

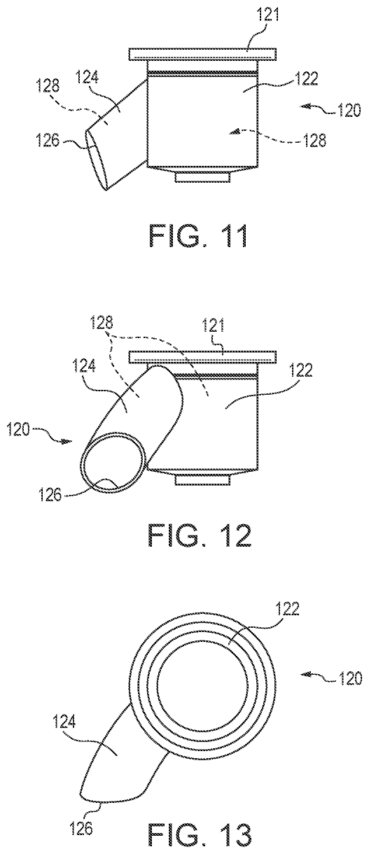

FIGS. 10-13 illustrate a cable guide tube component 120 used in the embodiment of the drain cleaner 10. FIG. 10 illustrates the second housing component 30 and the guide tube component 120 which is rotatably secured thereto. In the depicted embodiment, the guide tube component 120 is rotatably secured to the inner cone support member 70 and, the guide tube component 120 rotates about the previously noted axis X described in association with FIG. 4. The guide tube 120 promotes and/or assists in directing flexible drain cleaning cable (not shown) into and from the interior region 34 of the drain cleaner 10. The guide tube 120 includes a cylindrical trunk 122 and an arm 124 extending outward from the trunk to an arm distal end 126. The guide tube 120 defines a passageway 128 extending between an end 121 of the trunk adjacent the cable port 26 defined in the first housing portion 20, and the arm distal end 126. The passageway 128 is sized and shaped to accommodate the flexible drain cleaning cable being axially displaced therethrough. As will be understood, as flexible cable is extended from or withdrawn into the interior region 34 of the drain cleaner 10, the guide tube 120 rotates about axis X. Thus, rotation of the guide tube 120 occurs as flexible cable passes through, i.e., is axially displaced through, the passageway 128 extending between ends 121 and 126 of the guide tube 120, and is wound into a coil in the interior region 34. The direction of rotation of the guide tube 120 depends upon whether drain cleaning cable is being extended from the drain cleaner 10, or directed into the drain cleaner 10. Upon cable extension from the drain cleaner 10, the guide tube 120 rotates in a first rotational direction, i.e., clockwise or counter-clockwise. Upon cable retraction, the guide tube 120 rotates in a second rotational direction opposite from the first rotational direction.

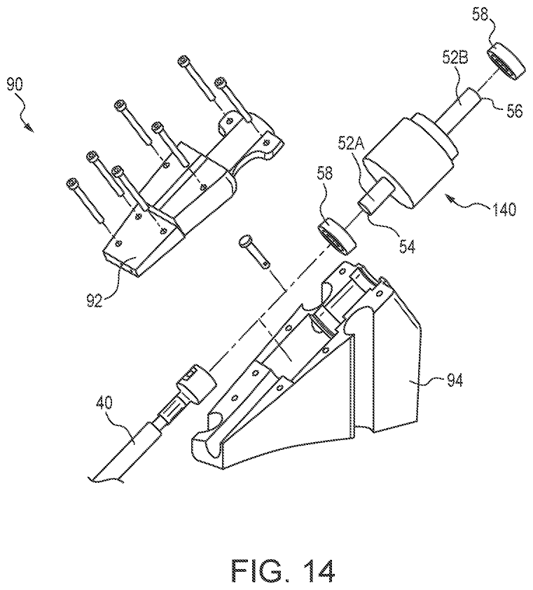

FIG. 14 illustrates the cable clamp mount assembly 90 previously described in association with FIG. 6. FIG. 14 depicts an optional use of a clutch assembly 140. The clutch assembly 140 provides a rotatably engageable and/or disengageable communication between the proximal end 54 of a first drive shaft portion 52A and the distal end 56 of a second drive shaft portion 52B. As will be understood, the clutch assembly 140 can be used to selectively disengage rotation from a rotary power source (not shown) such as applied to the distal end 56 of the drive shaft portion 52B, and a flexible cable 40 engaged to the proximal end 54 of the drive shaft portion 52A. In certain applications, application of high levels of torque to the rotary power shaft assembly 50 can damage the flexible drain cleaning cable engaged thereto.

Incorporation of a clutch assembly 140 can serve to prevent transfer of excessive levels of torque from a rotary power source to the drain cleaning cable and thereby prevent such damage. As previously described in association with FIG. 6, the various components can be supported using one or more bearings 58 and secured with first and second members 92 and 94. In a particular versions, the clutch assembly 140 can be in the form of a clutch with an internal spring-biased mechanism, and particularly a spring-biased detent mechanism. However, a wide array of clutch mechanisms can be used such as a drill clutch employing a series of roller balls or sliders and a spring plate with provisions enabling the plate to axially separate and temporarily disengage from another plate that is in mechanical communication with the drain cleaning cable.

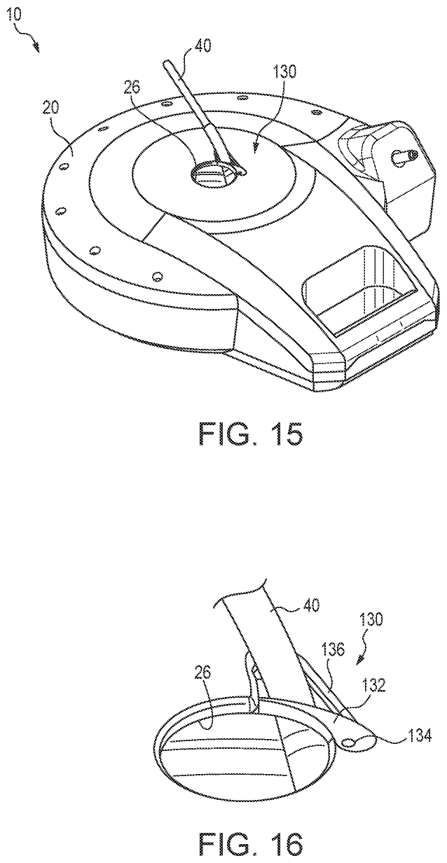

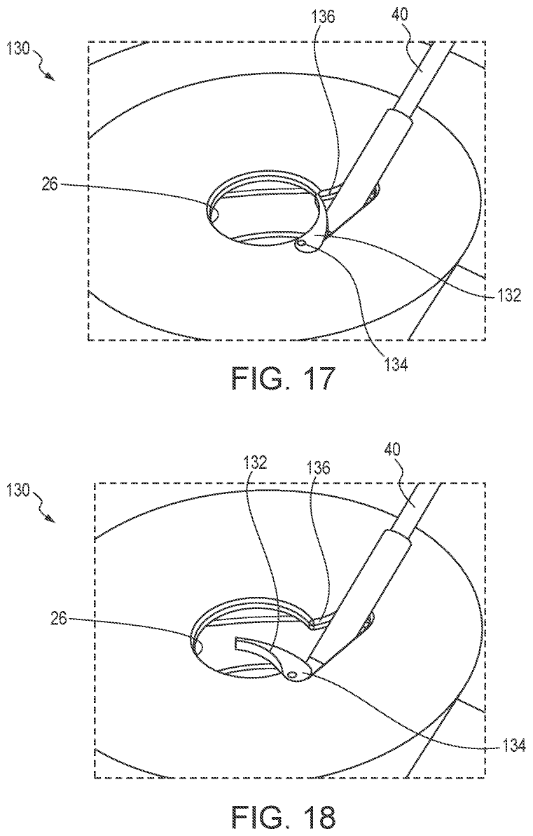

FIGS. 15-18 illustrate an optional locking clip assembly 130 used in the embodiment of the drain cleaner 10. The locking clip assembly 130 includes a pivotable member 132 movably secured at a base 134 adjacent the cable port 26 defined in the first housing component 20. In this version, the housing component 20 also defines a cable harbor 136 in communication with the cable port 26. The cable harbor 136 is sized and shaped to receive the flexible cable 40. The member 132 is positionable and pivotally secured at the base 134 to govern access to the cable harbor 136. As will be understood by reference to the figures, upon positioning the member 132 to an unlocked position such as shown in FIG. 18, the cable 40 can be positioned from the cable port 26 to the cable harbor 136, and vice-versa. The member 132 is also positionable to a locked position such as shown in FIG. 17 in which the member 132 blocks access or communication between the cable port 26 and the cable harbor 136. In certain versions, the locking clip assembly 130 also includes one or more biasing member(s) such as spring(s) to urge the member 132 to the locked position shown in FIG. 17.

The drain cleaner 10 is typically used as follows. An operator can conveniently carry the drain cleaner 10 containing a drain cleaning cable 40, by the handle 60 to a location of a clogged drain or other concern. If a distal end 44 of the cable 40 is secured to the housing of the drain cleaner 10, such as by the locking clip assembly 130, the member 132 is pivoted to its unlocked position. The cable 40 is then repositioned from the cable harbor 136 to the cable port 26. At this position, the cable 40 can be axially displaced relative to the drain cleaner 10. A rotary power source such as a hand-held drill is engaged to a distal end of the drive shaft 52 accessible along the exterior of the drain cleaner 10. The operator then manually pulls the cable 40 from the drain cleaner 10 and inserts a distal end 44 of the cable 40, to which a tool is typically attached, into a pipe or other member. Rotation of the tool is performed by actuation of the rotary power source, for example the noted drill. The operator can then push or otherwise displace the tool and distal end 44 of the cable 40 into the pipe until blockage or other obstruction is removed. The drain cleaning cable 40 can be conveniently wound within the interior region 34 of the drain cleaner 10 by the operator pushing the cable into and through the cable port. The guide tube 120 rotates within the interior region 34 and directs cable 40 into a neatly coiled stack arrangement. Upon returning all or a portion of drain cleaning cable 40 to the interior region 34 of the drain cleaner 10, the cable 40 can be securely retained to the housing 20 by placement of the cable 40 in the cable harbor 136 and locking the noted clip assembly 130.

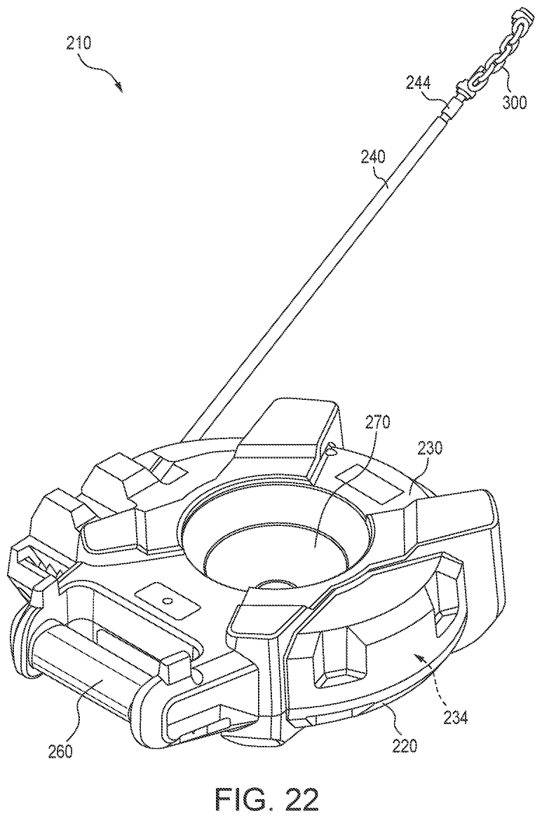

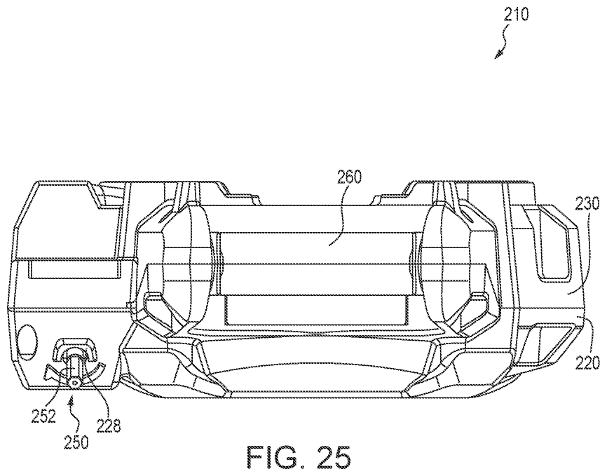

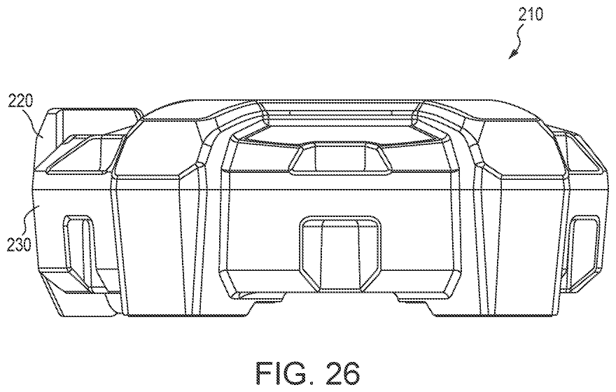

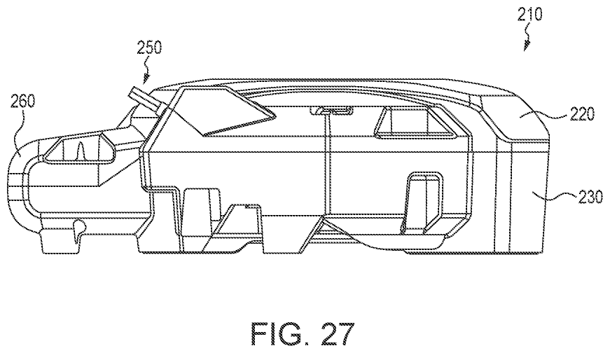

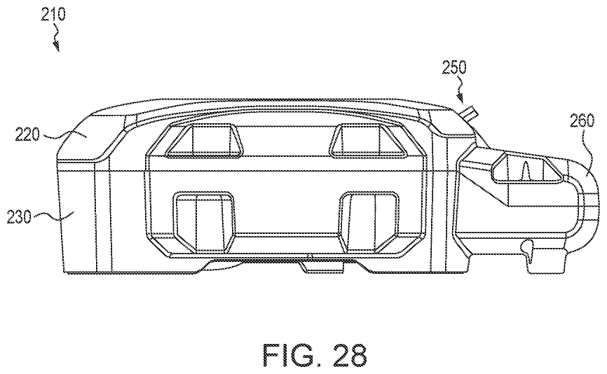

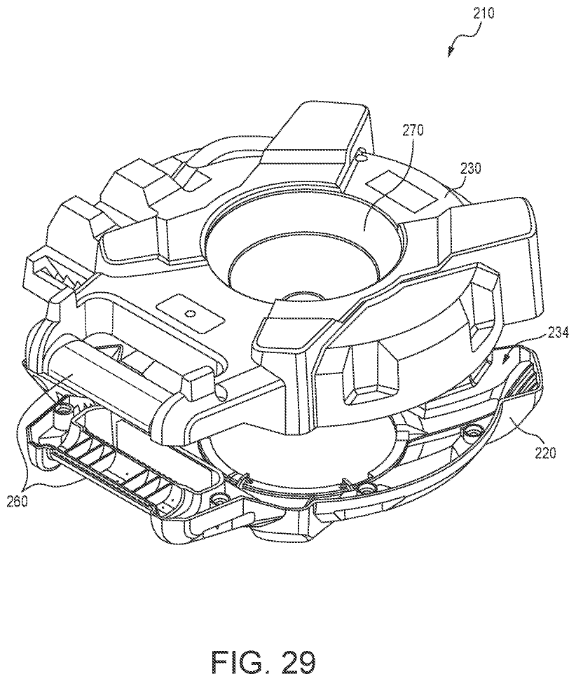

FIGS. 22 to 36 illustrate another embodiment of a drain cleaner 210 in accordance with the present subject matter. The drain cleaner 210 comprises a first or top housing component 220 and a second or bottom housing component 230. The top and bottom housing components 220, 230 are sized and shaped to matingly engage each other to define a generally enclosed hollow interior region 234. The present subject matter includes an embodiment utilizing a single or integral housing, i.e., without multiple housing components. The resulting housing is generally toroidal in shape. One or more sections of a flexible shaft drain cleaning cable 240 are disposed at least partially within the interior region 234. The flexible cable 240 defines a proximal end typically located within the interior 234, and an opposite distal end 244. Many of the figures illustrate an optional tool 300 engaged to the distal end 244 of the cable 240. The drain cleaner 210 also comprises a rotary power shaft assembly 250, generally supported by one or both of the top and bottom housing components 220, 230. The drain cleaner 210 may also comprise one or more handle(s) and/or gripping member(s) for facilitating carrying and/or use by an operator. In the illustrated embodiment, the drain cleaner 210 comprises a handle 260. As described in greater detail herein, the drain cleaner 210 also comprises an inner cone support member 270 as previously described which facilitates administration of flexible cable 240 within the interior region 234 of the drain cleaner 210. Further, the inner cone support member 270 may include a flat region 271 in addition to first and second conical regions similarly defined above as first conical region 74 and second conical region 80. The drain cleaner 210 also comprises a cable clamp mount assembly (not shown) as previously described disposed within the interior region 234 of the drain cleaner 210. As previously described in greater detail herein, the cable clamp mount assembly supports the rotary power shaft assembly 250 and orients the proximal end of the flexible cable 240 for improved engagement with the rotary power shaft assembly 250.

Referring further to the referenced figures, the first and second housing components 220, 230 are affixed or otherwise secured to each other. In the depicted embodiment 210, a plurality of fasteners 236 are used to releasably engage the first and second housing components 220, 230 together. As will be understood, apertures can be defined in the first housing component 220 and corresponding receiving members provided in the second housing component 230. The apertures and receiving members are aligned and adapted to engagingly receive the fasteners 236. As will be appreciated, other configurations and/or components can be used to secure the first and second housing components 220, 230 together. Also as previously noted, the present subject matter includes the use of a single housing rather than multiple housing components that are affixed or engaged together.

The drain cleaner 210 also defines an accessway 228 in one or both of the first and second housing components 220, 230 through which the rotary power shaft assembly 250 is accessible. In the depicted embodiment 210, the accessway 228 is in the form of an opening in the first housing component 220 sized and shaped to enable engagement to the rotary power shaft assembly 250. As described in greater detail herein, the accessway 228 is configured to allow convenient access to an outwardly extending drive shaft 252 of the rotary power shaft assembly 250. In certain versions, the accessway 228 is configured to also allow ready engagement to the drive shaft 252 extending outward at an acute angle or an angle between and including 0 degrees and 90 degrees, relative to a plane generally bisecting the housing components 220, 230, and generally parallel to their interface. It will be understood that the present subject matter includes a variety of arrangements and orientations of the accessway 228 and drive shaft 252. For example, the drive shaft 252 can in certain versions extend outward in a direction parallel to the noted plane. In such a configuration, the noted angle is 0 degrees. In another example, the drive shaft 252 can extend outward in a direction transverse to the noted plane. In such a configuration, the noted angle is 90 degrees.

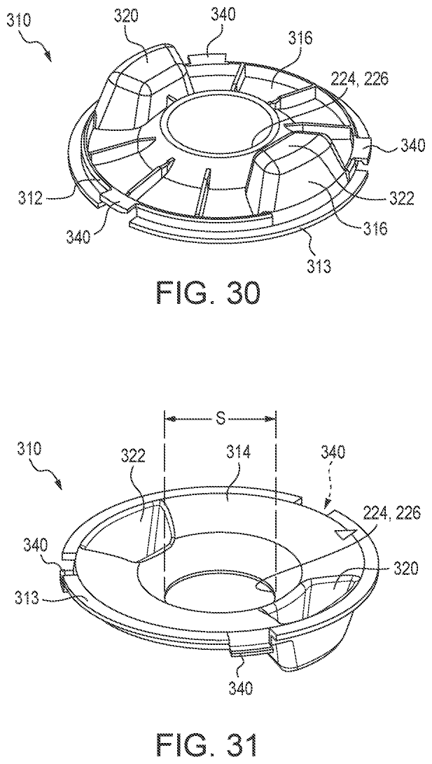

The drain cleaner 210 defines a centrally located opening 330 sized and shaped to matingly engage a removable housing cap 310. The opening 330 is typically defined in the first or top housing 220. As described in greater detail herein, the housing cap 310 allows for and/or facilitates a tool and distal end of the drain cleaning cable to be inserted and retained with the housing during transport of the drain cleaner 210. Upon desired use of the drain cleaner 210, the housing cap 310 is removed from the housing to thereby enable greater access to the interior region 234 and removal of the tool and distal end 244 of the drain cleaning cable 240. The tool and cable end are passed through a central aperture defined in the housing cap 310. As described herein, this central aperture is referred to as a cable outlet or cable port 226. Then, the housing cap 310 is re-engaged with the drain cleaner housing 220. The housing cap 310 shown in isolation in FIGS. 30-31, is configured to be selectively removable from the housing, and typically the first or top housing 220. The outer perimeter of the housing cap 310 may exhibit a wide array of shapes, such as circular, oval, square, rectangular, triangular, or polygonal. In the embodiment depicted in the referenced figures, the housing cap 310 defines at least one generally circular outer edge 312 and an outwardly extending lip 313, separating an outer face 314 and an oppositely directed inner face 316. In this version, the opening 330 defined in the first or top housing 220 is also generally circular. Typically, the size or maximum span of the opening 330 is sized to receive and accommodate the outer edge 312 of the housing cap 310. The lip 313 extends outward, a distance such that the maximum span of the cap 310 taken from between opposite locations on the lip 313, is greater than the maximum span of the opening 330. As will be understood, this configuration prevents unintended insertion of the housing cap 310 through the opening 330. As explained in greater detail herein, the housing cap 310 can be removed and/or disengaged from the drain cleaner 210 housing by partial rotation within the opening 330 to enable removal of the cap 310. Upon such removal, the exposed opening 330 enables greater access to the interior 234 of the drain cleaner 210.

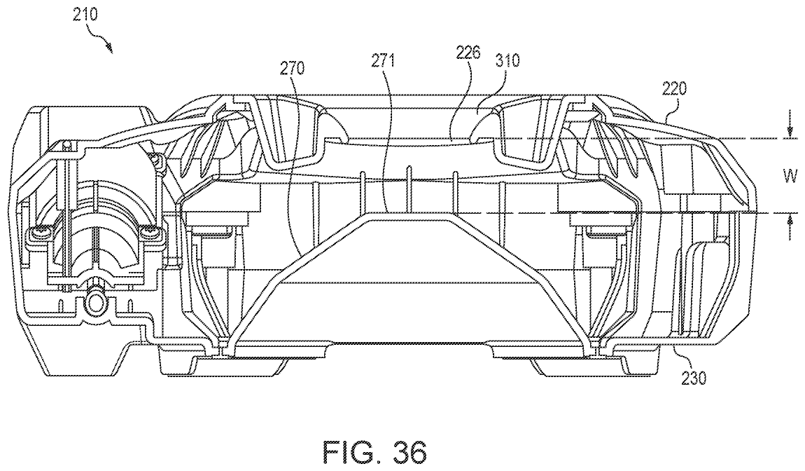

In certain embodiments, particular ratios are utilized for the size of the opening of the cable outlet or port, the interior headroom of the inner cone support member, and the outer diameter of the drain cleaning cable. Specifically, referring to FIG. 31, an opening span S is shown which represents the maximum size of the opening of the cable outlet such as the cable outlet 226. For versions in which the cable outlet 226 is a circle, the opening span S corresponds to a diameter of the opening. The interior headroom of the inner cone support member such as the support member 70 is depicted in FIG. 36 as headroom W. The interior headroom W is measured from the top or apex of the inner cone support member 270 and the opening 226 of the cable outlet defined in the housing cap 310. As will be understood, the outer diameter D of the drain cleaning cable such as cable 240 generally corresponds to the outer diameter of the sheath enclosing an inner cable. Utilizing particular ratios between S, W, and D are beneficial and promote ease of use and operation of the drain cleaners. A preferred ratio between the opening span S and the cable diameter D is from about 2 to about 8, and most preferably from about 4 to about 6.75. A preferred ratio between the headroom W and the cable diameter D is from about 2 to about 6, and most preferably about 3.3. A preferred ratio of headroom W and the opening span S is from about 0.3 to about 1.0, and most preferably about 0.6. It will be understood that the present subject matter is not limited to any of these ratios and includes a wide array of ratios outside of these ranges.

In certain versions of the housing cap 310, the cap 310 includes at least one gripping member to facilitate disengagement of the cap 310 from the housing of the drain cleaner 210. For example, in the version of the cap 310 depicted in FIGS. 30-31, the cap 310 includes a first recess or gripping member 320 taken with respect to the outer face 314. The cap 310 further include a second recess or gripping member 322, typically located opposite the first recess so that the cable outlet or cable port 226 is between the two recesses 320, 322. It will be understood that the present subject matter includes a wide array of components, configurations, and provisions for the gripping member(s).

As previously noted, the housing cap component 310 defines a centrally located cable outlet or port 226 providing access to the interior region 234 defined by the housing components 220, 230. In certain versions, the housing cap 310 also defines a conical tapered edge 224 extending about the cable outlet or cable port 226. The conical tapered edge 224 can be in the form of a funnel or depression along an outer face 314 of the housing cap 310 extending around the periphery of the cable outlet 226. As described in greater detail herein, upon placement of the flexible cable 240 within the interior region 234 of the drain cleaner 210, the distal end 244 and portion of the cable 240 can be extended through the cable outlet 226. The conical region 224 promotes and/or facilitates cable feeding, cable retrieval, or other cable administration operation(s).

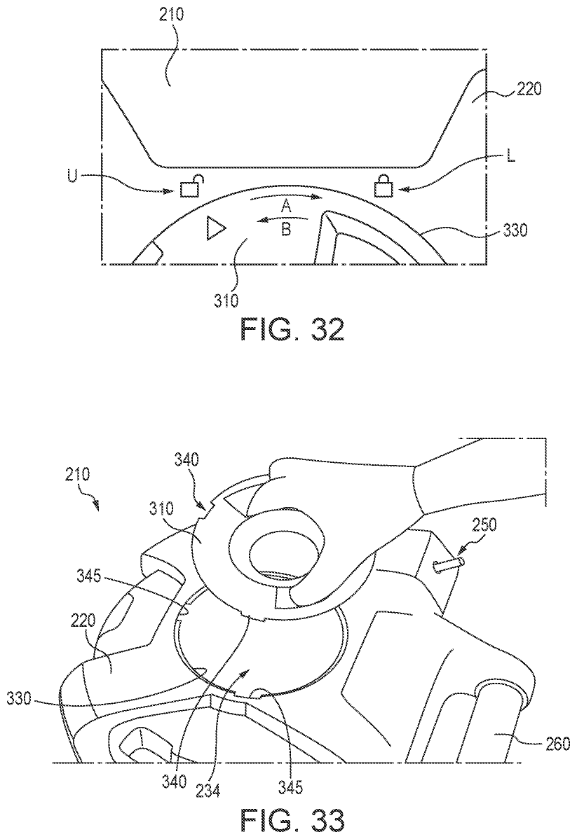

In certain versions, the drain cleaner 210 includes one or more locking assemblies that retain or further secure the housing cap 310 to the housing, which as noted is typically the first housing component 220. Specifically, the locking assembly secures the housing cap 310 in the opening 330 upon placement therein and positioning the housing cap 310 to a locked position shown as position “L” in FIG. 32. Specifically, upon initial placement of the housing cap 310 in the opening 330, the rotational position of the cap 310 is typically in the unlocked or “U” position. The cap 310 is secured and engaged to the housing component 220 by rotation in the direction of arrow A shown in FIG. 32. The housing cap 310 is removed from the housing component 220 by rotating the cap 310 toward the unlocked “U” position, i.e., in the direction of arrow B. In the unlocked position, shown as position “U”, the housing cap 310 can be removed, i.e., separated, from the housing component 220. Upon such removal, the opening 330 provides access to the interior 234 of the drain cleaner 210. Upon alignment and placement of the housing cap 310 in the opening 330, and rotation of the housing cap 310 to the locked “L” position, the housing cap 310 is securely retained with the housing.

A wide array of configurations and/or components can be used for the locking assemblies that selectively retain and engage the housing cap 310 to the housing of the drain cleaner 210. In a particular version, the locking assembly comprises at least one and typically a plurality of flexible tabs 340 extending outward from the outer edge 312 of the housing cap 310. A corresponding number of tab receiving regions 345 are defined in the opening 330 of the housing, e.g., the housing component 220, of the drain cleaner 210. The tab receiving regions 345 are positioned along the opening 330 so as to receive and accept the tabs 340 of the housing cap 310 upon alignment of the cap 310 with the opening 330. As will be understood by reference to FIGS. 30-33, upon appropriate alignment of the housing cap 310 with the opening 330, and insertion of the tabs 340 within the tab receiving regions 345, and ultimately within the interior 234 of the drain cleaner, the cap 310 can then be fittingly positioned relative to the housing. At this phase of engagement between the cap 310 and the housing, the cap 310 is in the unlocked position U as shown in FIG. 32. Upon rotation of the cap 310 relative to the housing, to the locked position L, the tabs 340 rotatingly slide along an interior surface of the housing and thereby securely retain the cap 310 thereto.

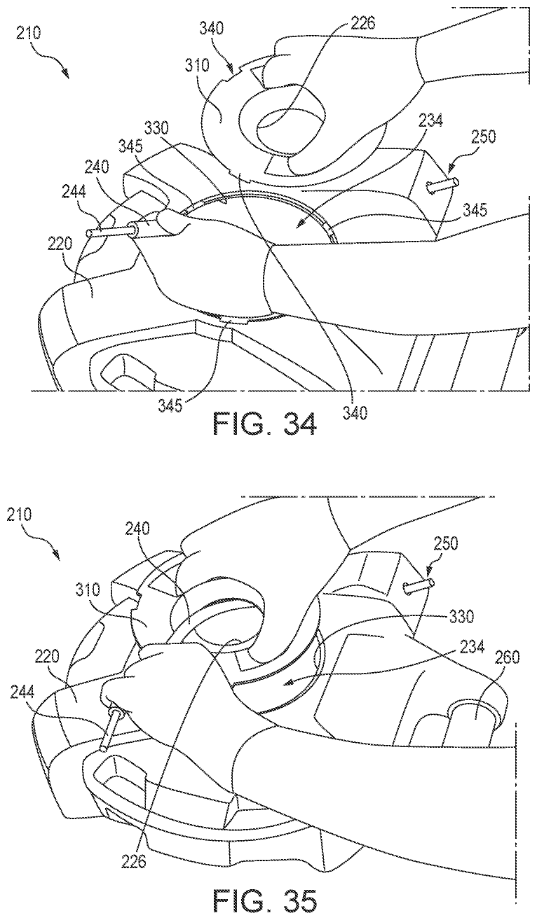

As noted, a wide array of techniques and configurations can be used to enable selective engagement and/or removal of the housing cap 310 from the housing. FIGS. 32-35 illustrate a series of operations to unlock and remove the housing cap 310 from the drain cleaner 210 and thereby release and/or expose a distal end 244 of the drain cleaning cable 240 for subsequent use. Specifically, after previous engagement of the housing cap 310 and positioning to a locked position L, a user rotates the cap 310 the unlocked position U as shown in FIG. 32. The user then removes the cap 310 from the housing and the opening 330 defined therein as depicted in FIG. 33. The interior 234 of the drain cleaner 210 can then be easily accessed. A user can then extend their hand through opening 330 into the interior region 234 and grasp the distal end 244 of the drain cleaning cable 240 as shown in FIG. 34. The user then positions the distal end 244 of the cable 240 through the cable outlet 226 defined in the cap 310, as shown in FIG. 35. The cap 310 can then be secured to the housing as previously described herein.

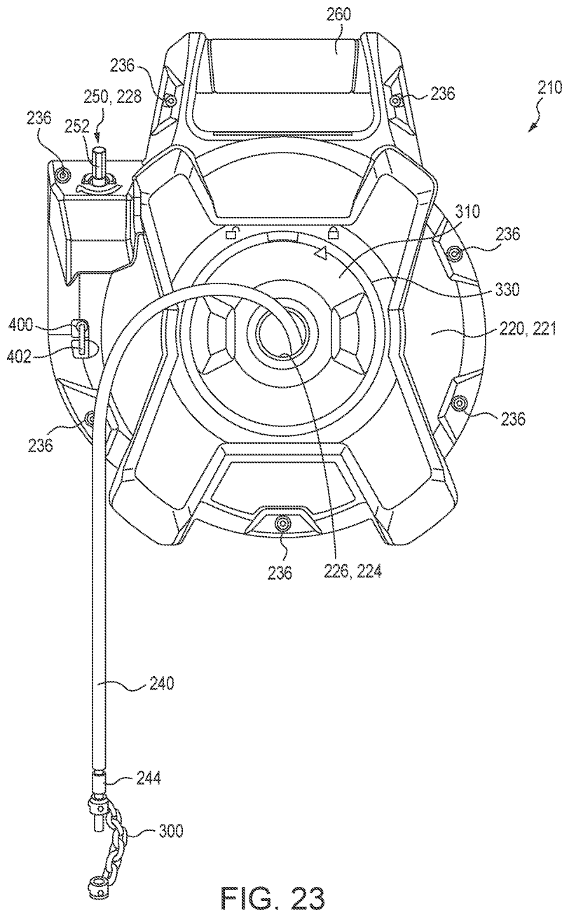

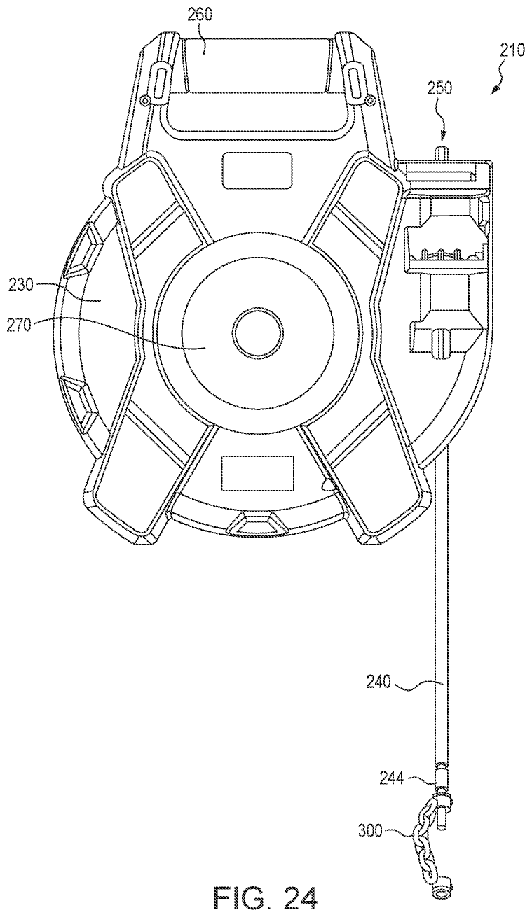

In certain embodiments, the drain cleaner can include on-board tool storage provisions. Referring to FIG. 23, a tool retaining member 400 is formed or otherwise provided in the housing or a housing component such as the first housing component 220. The member 400 is accessible along an exterior region of the housing or housing component. The member 400 is configured to receive and releasably retain a tool positioned therein. Although a wide array of releasable retention assemblies and/or configurations can be used, a non-limiting example is the use of one or more frictional engagement members that deform upon insertion or placement of a tool therein. Also included in the present subject matter are one or more tools 402 for placement and storage with the noted member 400. Non-limiting examples of such tools include one or more hex tools, one or more screw drivers, and one or more gripping tools such as pliers.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A drain cleaner comprising:
a first housing component;
a second housing component, the first and the second housing components sized and shaped to matingly engage each other to define a generally enclosed interior region;
a cable clamp mount assembly disposed within the interior region, the cable clamp mount assembly defining a shaft receiving region;
a rotary power shaft assembly for receiving rotary power, the rotary power shaft assembly disposed in the shaft receiving region and at least partially supported by the cable clamp mount assembly;
wherein the shaft receiving region defines an inclination angle within a range of from 10° to 80°.

2. The drain cleaner of claim 1 wherein the cable clamp mount assembly includes:
a first member;
a second member;
wherein upon engagement of the first member with the second member, the resulting engagement defines the shaft receiving region accessible at one end of the resulting engagement, and a cable receiving region accessible at another end of the resulting engagement.

3. The drain cleaner of claim 1 wherein the rotary power shaft assembly includes:
a drive shaft; and
at least one bearing for rotatably supporting the drive shaft.

4. The drain cleaner of claim 1 wherein the first housing component defines a cable port sized and shaped to enable axial displacement of a flexible drain cleaning cable from the interior region.

5. The drain cleaner of claim 4 further comprising a wear insert component secured to the cable port.

6. The drain cleaner of claim 5 wherein the wear insert component is rotatable with respect to the first housing component.

7. The drain cleaner of claim 4 further comprising a rotatable guide tube disposed in the interior region and defining a passageway sized and shaped to accommodate the flexible drain cleaning cable.

8. The drain cleaner of claim 4 wherein the first housing component further defines a cable harbor, and the drain cleaner further comprises a locking clip assembly governing cable access to the cable harbor.

9. The drain cleaner of claim 8 wherein the locking clip assembly includes a pivotable member positionable between a locked position in which access to the cable harbor from the cable port is precluded, and an unlocked position in which access to the cable harbor from the cable port is enabled.

10. The drain cleaner of claim 1 further comprising:
a clutch assembly in rotatably engageable communication with the rotary power shaft assembly.

11. The drain cleaner of claim 1 further comprising a removable housing cap, and wherein the first housing component defines an opening sized and shaped to engage the housing cap.

12. The drain cleaner of claim 11 further comprising a locking assembly for selectively retaining the housing cap to the first housing component.

13. A drain cleaner comprising:
a first housing component defining a centrally located cable port;
a second housing component, the first and the second housing components sized and shaped to matingly engage each other to define a generally enclosed interior region;
wherein the second housing component defines an inner cone support member, the inner cone support member and the cable port defined in the first housing component are aligned and share a common center axis.

14. The drain cleaner of claim 13 wherein the inner cone support member exhibits a dual conical configuration.

15. The drain cleaner of claim 14 wherein the inner cone support member includes a first conical region and a second conical region, the configuration of the second conical region being different than that of the first conical region.

16. The drain cleaner of claim 15 wherein the second housing component includes a planar wall defining an exterior face, the first conical region having a wall orientation at an angle within a range of from 45° to 80°, taken with respect to the planar wall.

17. The drain cleaner of claim 16 wherein the second conical region has a wall orientation at an angle within a range of from 10° to 45°, taken with respect to the planar wall.

18. The drain cleaner of claim 13 further comprising a wear insert component secured to the cable port.

19. The drain cleaner of claim 18 wherein the wear insert component is rotatable with respect to the first housing component.

20. The drain cleaner of claim 13 further comprising a rotatable guide tube disposed in the interior region and defining a passageway sized and shaped to accommodate a flexible drain cleaning cable.

21. The drain cleaner of claim 13 wherein the first housing component further defines a cable harbor, and the drain cleaner further comprises a locking clip assembly governing cable access to the cable harbor.

22. The drain cleaner of claim 21 wherein the locking clip assembly includes a pivotable member positionable between a locked position in which access to the cable harbor from the cable port is precluded, and an unlocked position in which access to the cable harbor from the cable port is enabled.

23. The drain cleaner of claim 13 further comprising:
a rotary power shaft assembly for receiving rotary power;
a clutch assembly in rotatably engageable communication with the rotary power shaft assembly.

24. The drain cleaner of claim 13 further comprising a removable housing cap, and wherein the first housing component defines an opening sized and shaped to engage the housing cap.

25. The drain cleaner of claim 24 further comprising a locking assembly for selectively retaining the housing cap to the first housing component.

26. A drain cleaner comprising:
a first housing component defining a centrally located cable port;
a second housing component, the first and the second housing components sized and shaped to matingly engage each other to define a generally enclosed interior region;
wherein the second housing component defines an inner cone support member;
a cable clamp mount assembly disposed within the interior region;
a rotary power shaft assembly for receiving rotary power, the rotary power shaft assembly at least partially supported by the cable clamp mount assembly.

27. The drain cleaner of claim 26 wherein the inner cone support member exhibits a dual conical configuration.

28. The drain cleaner of claim 27 wherein the inner cone support member includes a first conical region and a second conical region, the configuration of the second conical region being different than that of the first conical region, the first conical region having a wall orientation at an angle within a range of from 45° to 80°.

29. The drain cleaner of claim 28 wherein the second conical region has a wall orientation at an angle within a range of from 10° to 45°.

30. The drain cleaner of claim 26 further comprising a wear insert component secured to the cable port.

31. The drain cleaner of claim 26 further comprising a rotatable guide tube disposed in the interior region and defining a passageway sized and shaped to accommodate a flexible drain cleaning cable.

32. The drain cleaner of claim 26 wherein the first housing component further defines a cable harbor, and the drain cleaner further comprises a locking clip assembly governing cable access to the cable harbor.

33. The drain cleaner of claim 32 wherein the locking clip assembly includes a pivotable member positionable between a locked position in which access to the cable harbor from the cable port is precluded, and an unlocked position in which access to the cable harbor from the cable port is enabled.

34. The drain cleaner of claim 26 further comprising:
a clutch assembly in rotatable engageable communication with the rotary power shaft assembly.

35. The drain cleaner of claim 26 further comprising a removable housing cap, and wherein the first housing component defines an opening sized and shaped to engage the housing cap.

36. The drain cleaner of claim 35 further comprising a locking assembly for selectively retaining the housing cap to the first housing component.

37. A drain cleaner comprising:
a housing defining a generally hollow interior, the housing further defining a first face, an oppositely directed second face, and an inner cone support member extending within the hollow interior, the first face defining an opening;
a cable clamp mount assembly disposed within the hollow interior, the cable clamp mount assembly defining a shaft receiving region that defines an inclination angle within a range of from 10° to 80°;
a removable housing cap sized and shaped to releasably engage the opening defined in the first face of the housing.

38. The drain cleaner of claim 37 further comprising:
a rotary power shaft disposed in the shaft receiving region defined by the cable clamp mount assembly.

39. The drain cleaner of claim 38 further comprising:
a clutch assembly in rotatable engagement with the rotary power shaft, the clutch assembly disposed in the hollow interior defined by the housing.

40. The drain cleaner of claim 37 further comprising a locking assembly for selectively retaining the housing cap to the housing.
